(19) United States
(12) Patent Application Publication
(10) Pub. No.: US 2007/0047701 A1
(43) Pub. Date: Mar. 1, 2007

(54) INTERNET ALERTS

(75) Inventor: STEVE MORRIS, Fife (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Elertz Limited

(21) Appl. No.: 11/457,994

(22) Filed: Jul. 17, 2006

(30) Foreign Application Priority Data
Jul. 15, 2005 (GB) 0514556.0

(51) Int. Cl. H04M 11/00

(52) U.S. Cl. 379/100.08

(57) ABSTRACT

The present invention relates to a method for providing a non-email based precision web alert for a website or web-based application. The method involves the publisher registering at least one alert at an alert server and then presenting the alert on the related website or web-based application for selection by a user. When the alert is selected, the user can define at least one alert variable, such as an alert parameter and/or operator and/or threshold. When an event associated with the alert occurs, an event notification is posted by the website publisher at the alert server. Dedicated alert software at the user's terminal polls the alert server to identify any event notifications for selected alerts with the user-defined variables. When an event notification is identified, the alert software generates an alert notification at the user's terminal. In this way, non-email, precision alerts can be delivered to a user.

### BACKGROUND OF THE INVENTION

1. Field of Invention

The present invention relates to a precision internet alerting process that facilitates a new broadcast communication method between websites and their end-user communities.

2. Description of the Related Art

Many alert systems are currently available on the Internet. However, most of these are not precision alerting systems. For precision alerting whereby subscribers elect to be told only about specific events with user-determined precision (for example on a dating site where subscribers only wish to be informed of the availability of a new member based on gender, age, size and location), only email-based systems have been utilised. However, email based systems suffer from not being anonymous and prone to spam. In addition, much broadcast email is increasingly becoming erroneously trapped by spam and junk email filters. Therefore, there is a need for a non-email based precision alerting system that can facilitate broadcast communication that is anonymous and under the control of the subscriber.

Other alerting systems exist but none have anonymity, genericism and precision. For example, Google provides an alerts service that utilises Google spider technology to do automated offline searches that can be refined to include only new links. When new links are found, alerts are delivered to the user via email. A problem with this and other e-mail based arrangements is that the alerts are not in real time and they are slow and unreliable. Furthermore, there is a loss of anonymity. All users who subscribe to an email based alert must at the very least supply an e-mail address. This can make users reluctant to sign up for alerts because of SPAM concerns and the lack of control of the alert process. A further problem is that many alert based systems operate by web spiders analysing websites and trying to second-guess significant changes on a website that would elicit alerts. Second guessed alerts are very imprecise and often lead to ‘False positives’ and the subsequent inclusion of unnecessary and unrelated pages.

Another type of web-based alert system is the so-called RSS news feed. RSS stands for Really Simple Syndication (RSS). This is a lightweight XML format designed for sharing headlines and other Web content. This type of alert is typically used for ticker tape applications, especially for news sites. RSS can be used to some degree generically but is typically site based. A site utilising RSS news feeds could be organised to issue new information as it becomes available, but the granularity is limited to page level and the attributes are limited to a textual title and a textual description. For RSS deployment, specific client software needs to be installed on a web publisher's site to issue the feeds. The precision of RSS based feeds is limited and the selectivity of the subscription process is basic and imprecise. In addition, the subscriber has to subscribe to each site providing alerts separately, which means the client software has to poll many sites. Although other, more sophisticated alerting systems have been developed whereby RSS aggregators can supply alerts to users (often through email e.g. NewsGator) there is no facility for users to undertake precision subscription which would be required by a sophisticated Internet based application such as a dating site. In addition, for RSS (and similar technology such as Atom) a title and description of the page associated with the RSS feed has to be published in XML, which is freely available. This makes it inappropriate for complex internet based applications requiring limited secure access, such as Internet banking.

RSS feeds are used in the Open Source Mozilla Firefox browser, which has a feature called live bookmarks. (See http://www.mozilla.org/products/firefox/live-bookmarks.html) This allows the RSS feeds to be used as bookmarks. These are dynamically changed with the RSS feed. However, a problem with this arrangement is that it cannot be utilised for specific alerts with high levels of precision and low levels of granularity. In addition, alerts cannot be notified by publisher-defined attributes. Finally, the client software (in this case the browser) has to interrogate every web site that it has subscribed to for feeds, which makes it impractical for a user with many alerts set up.

To overcome the problem of how to handle many alerts, under the RSS 2.0 open standard, it is possible to have aggregators that behave as RSS ‘clouds’. However these clouds distribute their feeds using push technology using the subscriber IP address, so it is not anonymous and requires the subscriber to re-subscribe when on a new IP address. Also, they do not work behind a NAT firewall where subscribers have internal IP addresses. Furthermore, no matter how much the RSS protocol is enhanced it will never be suitable for working with complex internet applications such as online parcel tracking systems.

WO 03/049368 describes a messaging system, which has alerting attributes. This uses pull technology in which a desktop client application polls a remote server to identify whether any messages are available for it. These messages include content for the user, and so are encrypted to ensure privacy when the message is transmitted. This is primarily a messaging system not an alerting system. It provides a more secure method of communication than email, but requires authentication between the broadcaster and the recipient. This means that it is not anonymous. It also requires specific, authorised deployment by the publisher to a broadcaster, because of the intrinsic authentication between subscriber and broadcaster. This prevents the publisher from implementing the system on their web site without technical assistance, and means that the system is not generic. This system has potential for some level of granularity using publisher defined drop down lists that the subscriber can select, but it is imprecise.

Yet another system that is available is Microsoft .NET alerts. These utilise MSN messenger as the protocol for distributing alerts. This is a generic solution that any site can use but because it utilises MSN messenger it is essential for users to have a .NET passport and is therefore not anonymous.

### SUMMARY OF THE INVENTION

According to one aspect of the invention, there is provided an alert system comprising: an alert server adapted to register a web site alert; receive from the website a signal indicative of an event associated with the alert; and generate a notification indicative of the event for client software at a user's terminal to access. Preferably, the notification does not include information on the event, but instead is pre-determined and merely indicates that an event has occurred. In addition, the notification preferably does not include any user identifiers, which means that the notification process is completely anonymous.

The invention provides a means for alerting a user to events that have occurred on a web site or a web based application, but not for messaging. The publisher holds the change of content information, and only a notification of the occurrence of an event is sent to the alert server and made available to the client software. This means that security requirements do not have to be resolved as part of the alert process, instead this can be deferred to when the user attempts to access the information on the publisher's web site. This greatly simplifies the alerting process, and preserves user anonymity.

The alert server uses alert subscription information from the publisher's web site or the publisher's web application. To allow a user to subscribe to an alert, the website or web application includes a user selectable link. This may include user selectable parameters. The parameters may be one or more precision Boolean logic values and operators. Boolean operators may include at least one of ‘Equal to’; ‘Less than’; ‘Greater than’ and ‘Not equal to’. In this way publishers can present subscribers with precision alerting thresholds such as minimum or maximum buying or selling price. The precision thresholds can be applied by numeric values such as price or weight and to date and times such as older than or newer than.

The alert server may be adapted to provide code for the user selectable link for putting on the web publisher's site. Preferably, the code consists solely of HTML and/or Java script. This is an advantage, because it means that the alert can be implemented and self provisioned by any publisher on any web-based system. Preferably the code is a schema.

The alert server may be adapted to allow a plurality of different alerts for different web sites to be registered. This is advantageous as it means that notifications for many different alerts can be provided in a single area accessible by the client software, which avoids the need for the client software to have to poll multiple web sites.

According to another aspect of the invention, there is provided a method for allowing user anonymous access to an alert comprising registering a web publisher alert at an alert server; receiving from the web publisher at the alert server notification of an event associated with the alert; and using dedicated alert software at the user's terminal to poll the alert server to identify a notification and in the event that a notification is identified generate an alert notification at the user's terminal. Preferably, the alert notification is presented as a temporary entry in the favourites list of the user's internet browser. Preferably the alert notification includes a link to a target URL.

By using dedicated alert software at the user's terminal to identify alerts at a remote server, the need to use email or RSS based solutions can be avoided. This does not require specific programs to be deployed by the web site publisher and can be implemented as a purely HTML and/or Java script based solution. Furthermore, it overcomes the fundamental flaws of email as a broadcast communications medium, and is completely generic, so that any website can be enabled to use it. Because the alert software polls the alert server, and the alert server notification does not include any user identifiers, instead only information relating to its associated alert, registering interest for a website alert by the end user is anonymous and does not require any personal information or email address. Finally, the alert can be modified and deleted by the end user preventing any unsolicited alerting from the website, which makes it SPAM proof.

The method may involve allowing subscriber selection of one or more precision Boolean logic values and operators and storing these in association with the subscriber's registered alert request. By allowing a subscriber to select Boolean values and operators, a website can define one alert which can be subscribed to in different ways by different end users. This is a significant practical advance and opens the way for precise targeting to users. For example, a website selling classic cars may ask the user to subscribe for alerts by model and price for vehicles that are not currently available. The web publisher may define two parameters ‘model’ (text based) and ‘price’ numeric. Customer ‘A’ may subscribe to the alert using model of ‘etype’ and price less than 10,000. Whereas customer ‘B’ may subscribe to the same alert using model ‘etype’ but price less than 8,000. If the web publisher then publishes a new page with an ‘etype’ model and a price of 9,000 and then issues a notification to this affect only Customer ‘A’ will be notified as the price will be too high for the price selected by customer ‘B’.

Alerts may optionally be issued to other devices should the user choose to do so, for example when the user is offline he may elect to have the alert message issued as a text message to a nominated mobile phone.

The method may involve receiving alert information from a web publisher and generating alert code for the publisher to include on their website, the alert code including a link to an active alert on the alert server. Selection of the alert code by a user causes the alert to be registered with the user's alert software. This registers that alert for the user who selected it.

In the event that the user is identified as unregistered, a registration process is commenced causing the dedicated alert software to be downloaded to the user's terminal. Subsequently, if the web publisher up-dates information associated with the alert, this is noted on the alert server, which generates a code or identifier recognisable by the client software on the user's terminal. The client software is operable to poll the alert server to identify up-dates and in the event that an up-date is found, notify the user by generating a user alert at the user's terminal.

According to another aspect of the present invention, there is provided a method for alerting a user to an event on a web site, the user's terminal having alert software that is operable to poll an alert server, wherein the method comprises registering an alert at an alert server; receiving notification at the alert server of an event on the web site; and generating at the alert server a notification for indicating to the user's alert software that a change has occurred, this notification being accessible when the alert software polls the alert server.

According to yet another aspect of the present invention there is provided an alert system for alerting a user to events on an internet web page or site or web-based application, the system being arranged to register a web publisher alert; receive up-date information from the web publisher indicative of a change in information associated with the alert, and notify web alert software at a user's terminal of the up-date. The system may be arranged to receive alert details from a web publisher and provide alert code for the publisher to include on their website, the alert code including a link back to the alert server. The link is user selectable and operable to direct a user to a register for registering to receive up-date information associated with the link.

According to still another aspect of the invention, there is provided a computer program, preferably on a data carrier or a computer readable medium, the program having code or instructions for registering a web publisher alert; receiving up-date information from the web publisher indicative of an event associated with the alert, and generating an event notification at the alert server that can be accessed by web alert software at a user's terminal.

According to a further aspect of the invention, there is provided a computer program, preferably on a data carrier or a computer readable medium, the program having code or instructions for: storing at least one alert subscription identifier received from a website in response to a user selection of an alert; polling an alert server for event notifications for the or each subscribed to alerts; and generating an alert message at the user's terminal in the event that a notification is identified.

Preferably, the computer software is configured to include an alert identifier in the user's browser, for example, in the user's favourites list. Preferably, the computer program is operable to change the alert identifier when an event has occurred in connection with that alert.

Preferably, the alert message is user selectable. Ideally, the alert message is arranged to cause the user's browser to navigate to a target URL that is associated with the alert.

The computer program may also include code or instructions to notify the alert server when it is active and/or inactive. The computer program may also include code or instructions to notify the alert server of a diversion of alert notifications to a subscriber's offline device, such as a PDA or mobile telephone.

### BRIEF DESCRIPTION OF THE DRAWINGS

Various aspects of the invention will now be described by way of example only and with reference to the accompanying drawings of which

FIG. 1 is a block diagram of a system for implementing alerts;

FIGS. 2a-c is a flow diagram of a method for implementing alerts;

FIG. 3 is a flow diagram of the process for registering a user for an offline notification;

FIG. 4 is a screen shot of the message box that prompts the user to include the example alerts once the linking code hyperlink has been clicked;

FIG. 5 is a screen shot of a browser toolbar in which an example alert has been enabled;

FIG. 6 is a flow diagram that illustrates the offline notification process;

FIG. 7 is a screen shot of the browser once a selected alert is activated by firing of an alerts notification string, and

FIG. 8 is a screen shot of the browser after the activated alert of FIG. 7 is selected.

### DETAILED DESCRIPTION OF THE DRAWINGS

The present invention relates to a system and method for initiating internet based alerts from websites and website based applications to end users without the need for the alerted party to register on the website. The process is completely generic and is an HTML and Java script based solution that does not require any bespoke programming by the web publisher. Furthermore, variable elements to the alert can be defined by the web site so that a user can select specific types of alert to be notified of depending on the values of these variable elements, for example variable alert parameters and associated operators. Moreover the alerts can be modified or deleted by the subscriber preventing unsolicited messages and SPAM.

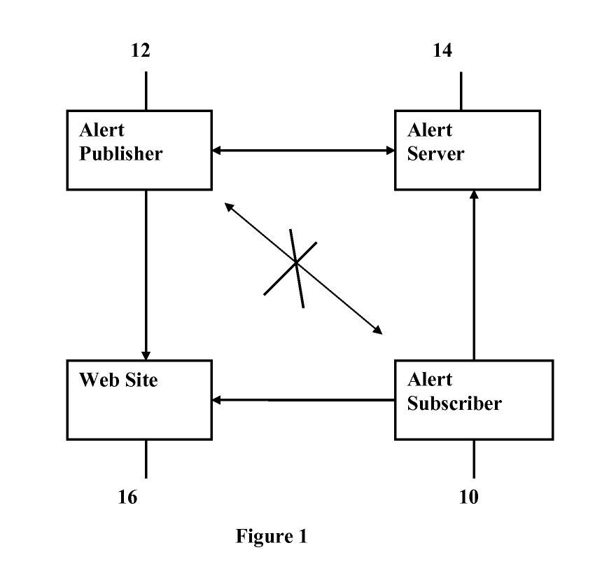

FIG. 1 shows a system for alerting users to changes in the content of a website. This has three different participants—an alert subscriber 10, an alert publisher 12 and an alert server 14. The publisher 12 owns or controls a website 16 that contains alert linking code. The subscriber 10 is an end user who elects to receive alerts relating to content on the website 16, and who may optionally register to receive offline as well as on-line alerts notifications. The alert server 14 is an internet connected server that facilitates alerts between the publisher 12 and the subscriber 10 and has one or more servers/processors for controlling the overall alert process. Internet communication between the alert subscriber and the alert server 14 is preferably unidirectional, with the subscriber able to contact the alert server 14, but the server unable to contact the subscriber directly on-line. The alert server 14 can communicate with the alert subscriber 10 on-line via any internet enabled device (i.e. a PC or a PDA) or offline by any subscriber nominated device (i.e. text message to a mobile phone).

To interact with the system, an alert subscriber 10 must have access to dedicated client software that can recognise an alert linking code when the user 10 subscribes to a nominated alert (linking code) that has been placed on a web publisher's website 16. This can be any type of client software that is enabled to store alert subscriptions, poll the alert server 14 for alert notifications, navigate to notified target URL's, notify the alert server 14 when active and/or inactive and notify the alert server 14 of a diversion of alert notifications to a subscriber's nominated offline device. Typically, the client software is installed in the user's browser, and an icon, for example a star, is included in the toolbar to indicate its presence. Preferably, the client software is operable to create an alert bookmark in the user's favourites list for each new alert selected or subscribed to.

When connected to the internet, the client software must poll the facilitating alert server 14 to look for notification of subscriber alerts within a selected parameter range. Each notification is indicative only of the availability of an event, such as new information, on the web publisher's site 16 and does not include the new or changed information itself. This is advantageous as it avoids the need for security in communications between the client software and the alert server 14. In addition, each notification is identified only with a particular alert and is not identifiable as being associated with a particular user 10. This means that whilst the client software can identify alerts that its user 10 has subscribed to, the alert server 14 cannot identify subscribed users 10. This means that complete user anonymity is preserved. In the event that the client software identifies a notification for an alert that its user has subscribed to, receipt is made and the client software icon is caused to change visually (for example by flashing red). The notified alert bookmark will also flash and change colour (typically red). The user 10 can then navigate to the target URL by selecting the bookmark and the status of the alert becomes inactive again.

Because the alert notification only contains information pertaining to alerts and is not a real message, this makes it easy for a publisher 12 to self provision the deployment on their website without security concerns. If secure messaging is required between the subscriber and the publisher 12 (for example internet banking) then this is the responsibility of the publisher 12 who can deploy whatever security measures he sees fit (i.e. HTPPS, passwords etc) when allowing the subscriber to access the data associated with the alert.

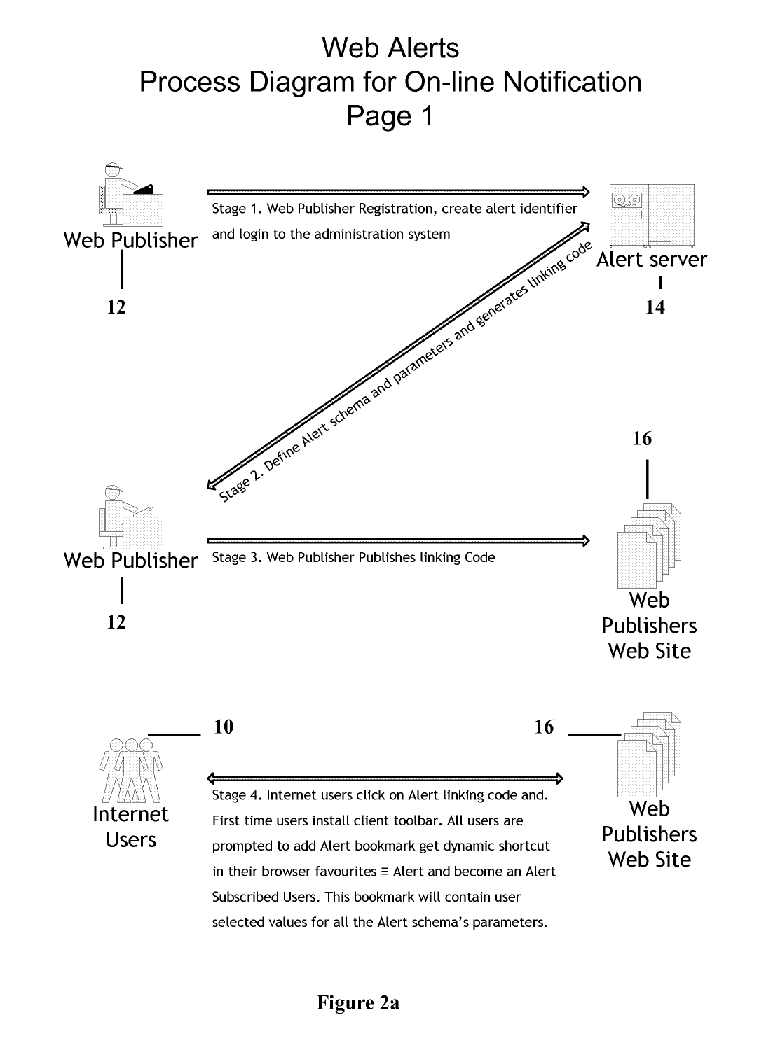

FIG. 2 shows the steps that are required to set up an alert for on-line notification. The first step is the for web publisher 12 to register with the alert server 14 and so receive a unique web publisher alert identifier (stage 1). Then, the publisher 12 logs into the alert server administration service (not shown) to define an alert schema (stage 2). Each schema defined by the publisher is stored at the alert server 16, which maintains a record of all registered alerts, and their schemas. Each schema is a web publisher 12 defined alert that has a number of attributes, including fixed attributes and web publisher 12 defined parameters and Boolean operators. The parameters can be textual, numeric or date time format. In general, numeric and date time parameters are used in combination with alert operators. The default operator for text parameters is ‘Equal to’ and does not need to be explicitly defined. Other operators include ‘Less than’ ‘Greater than’ and ‘Not equal to’.

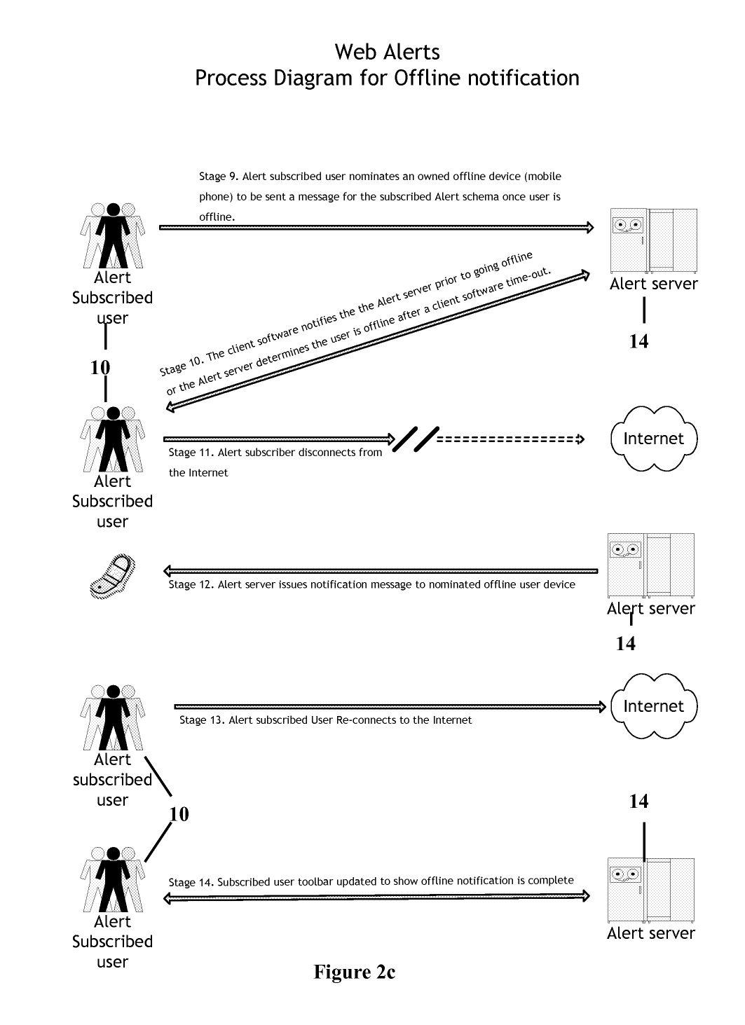

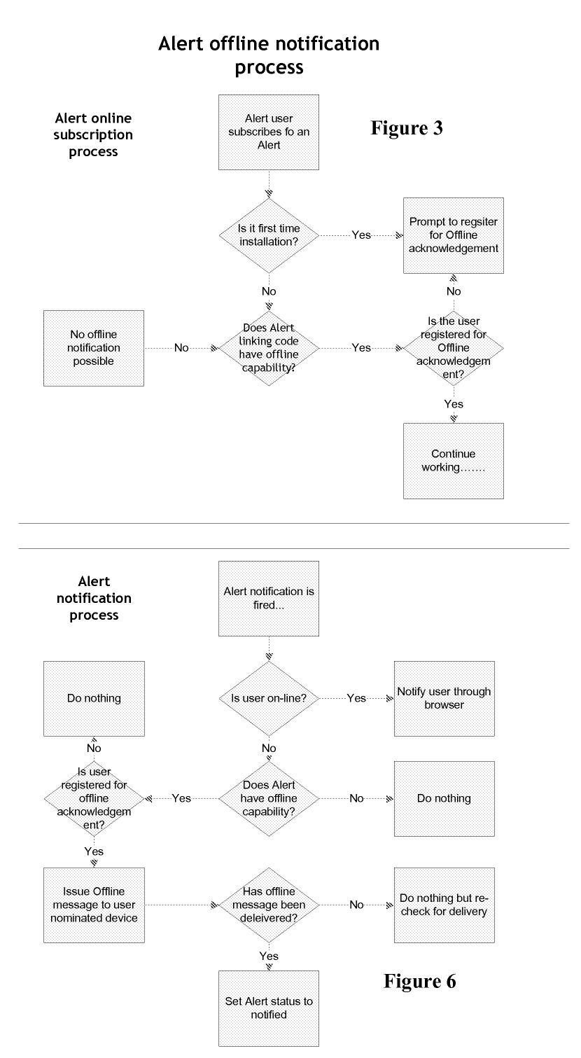

Once the schema is defined, linking code is generated and downloaded to the web publisher 12. This will be described in more detail later. The linking code is then published by the web publisher 12 on the website and acts as a link to allow users 10 to subscribe to the alert (stage 3). In the event that an internet user clicks on the linking code, they are prompted to confirm whether they are a first time user (stage 4). If yes, then alert client software is downloaded and installed as part of the toolbar of the first time user's browser. At this stage, the user is also asked whether off-line notification is required in the event that an alert is generated when they are off-line. This will be described in more detail later. Then the user is prompted to accept or decline the alert subscription in a message box with the message box description in it, as shown in FIG. 4. In this case, the message box description is ‘Classic Car Alert’. If the alert subscriber accepts the subscription invitation, then the alert subscriber's client software installs the alert bookmark as a dynamic shortcut in their browser favourites list, as shown in FIG. 5. At this stage the user 10 becomes a subscriber to the selected alert.

When an event occurs in connection with the published alert, the web publisher 12 posts an alert event notification on the alert server 14 (stage 5) using an alert post string populated with the required parameters. This notification is available to all users 10 who subscribed to that alert. The client software at each user's terminal polls the alert server 14 looking to detect notifications for their subscribed alerts that correspond to their user's selected parameter choice (stage 6). When a notification is detected, the client software causes its toolbar icon to change in some manner, typically by causing it to flash and/or change colour, thereby to alert the user 10 to event notification. In addition, the bookmark for that alert is caused to become active and a dynamic shortcut is created. The alerted subscriber 10 then acknowledges an alert notification to the alert server 14 and all current favourites in the browser of that subscriber are displayed, including the dynamic favourite (stage 7). Selection of the dynamic bookmark by the user 10 causes their browser to navigate to the target URL on the publisher's web site 16. The dynamic favourite then returns to its inactive state (stage 8).

When the user 10 has elected to receive an off-line notification, an off-line device has to be nominated (stage 9). Details of the nominated device are stored at the alert server 14. The client software is configured to notify the server 14 in the event that the user 10 goes off-line (stage 10). Alternatively, the alert server 14 is operable to determine the user 10 is off-line after a client software time-out. In either case when the user 10 disconnects from the internet, this can be detected by the alert server 14 (stage 11). When this happens, and an alert event notification is received from the web publisher 12, the alert server 14 is operable to send a message to the user's nominated device, for example mobile telephone. Typically the message is an SMS text message (stage 12). The user 10 can then connect to the internet when convenient (stage 13). Once this is done, a dynamic shortcut is created (stage 14) and the user 10 can navigate as before to the target URL.

A key feature of the invention is the ability to define precision alerts, i.e. alerts that can be accurately targeted to users 10 as a function of user defined parameters. The level of precision that is available to each user is defined by the publisher 12, when the alert schema is being defined.

Consider an example of a web publisher 12 who has a website that sells classic cars called www.elertzcars.com. The website owner becomes an alert publisher 12 by first registering as an alert publisher 12 by registering on the alert server 14, say www.elerz.com. At this stage, the publisher 12 is allocated a unique identifier, for example 2, and a login/password to access the server administration services. Then, the publisher 12 is allowed to create an alert schema. Each alert schema must have a unique textual name that is defined by the web publisher 12, for example ‘cars in demand’. Within the schema, the publisher 12 can define one or more alert parameters. For example for the “cars in demand” alert, the publisher 12 may decide to include a text based parameter ‘model’ and a numeric parameter ‘price’ selected with the less than operator. The alert publisher 12 can then define an alert bookmark using these parameters. In this case, the alert bookmark could be ‘Car is model less than price’. The emboldened terms ‘model’ and ‘price’ are recognised as parameters and the underlined text is recognised as an operator. Similarly, the publisher 12 may optionally define an offline message using, text, parameters and operators. In this case, ‘A new model for price dollars has just been made available at target_url’. In this as well as the emboldened ‘model’ and ‘price’ parameters, there is also the system parameter of ‘target_url’. This is the alert target URL, which is typically defined upon notification.

Other attributes defined with the schema by the alert publisher 12 at this stage include ‘First time URL’ which is the URL used when the subscriber first installs the client software. For the example given above, the URL would be ‘www.elertzcars.com’. In addition, a ‘place holder URL’ is defined. This is the default URL that the alert bookmark will navigate to prior to being sent a target URL during the alert notification process. Another attribute that is defined is the ‘Message box text’. This is a purely textual attribute that includes the text that will be displayed in a message box prompt when the subscriber elects to receive the alert, for example ‘Classic car alert’, as used in the example of FIG. 4. Once all the attributes have been defined, the publisher 12 can utilise the alert server administration system to generate linking code or can manually generate their own. This linking code needs to be cut and pasted on to the publisher's website 16 with appropriate java script put in place to populate the parameters from combinations of web controls. Typically, a drop down list is provided, for example a list of classis cars, as well as a textbox to select other parameters, such as maximum price.

An example of the linking code for the “classic car” example is as follows:

http://www.elertz.com/elertz/alert.asp?name=Car+is+etype+less+than+10000&schema_id=71& place_holder_url=http://www.elertzcars.com&webmaster_id=2&first_time_url=http://www.elertzcars.com&message_box_description=Classic+car+alert&model=etype&price=10000

This linking code breaks down in to the following components:

http://www.elertz.com/elertz/alert.asp:

The alert server 14 side script that processes alerts book_mark description=name=Car+is+etype+less+than+10000:

The book mark description text with parameters and operators. Plus signs represent space characters.

schema_id=71:

The schema unique identifier (in this case 71)

place_holder_url=http://www.elertzcars.com:

The place holder URL

webmaster_id=2

The web publisher unique identifier (in this case 2)

first_time_url=http://www.elertzcars.com:

The first time URL

message_box_description=Classic+car+alert:

The message box description. Plus signs represent space characters.

model=etype:

User defined parameter of ‘model’ with a temporary placeholder value of ‘etype’. This will be replaced by web publisher java script by the ‘model’ selected by the alert subscriber price=10000:

User defined parameter of ‘price’ with a temporary place holder value of ‘10000’. This will be replaced by web publisher java script by the maximum price selected by the alert subscriber. Any alert subscribed user 10 can at any time modify the values of any numeric parameters associated with their subscribed alert and can also delete the bookmark. This prevents any unsolicited messages from the web site or SPAM.

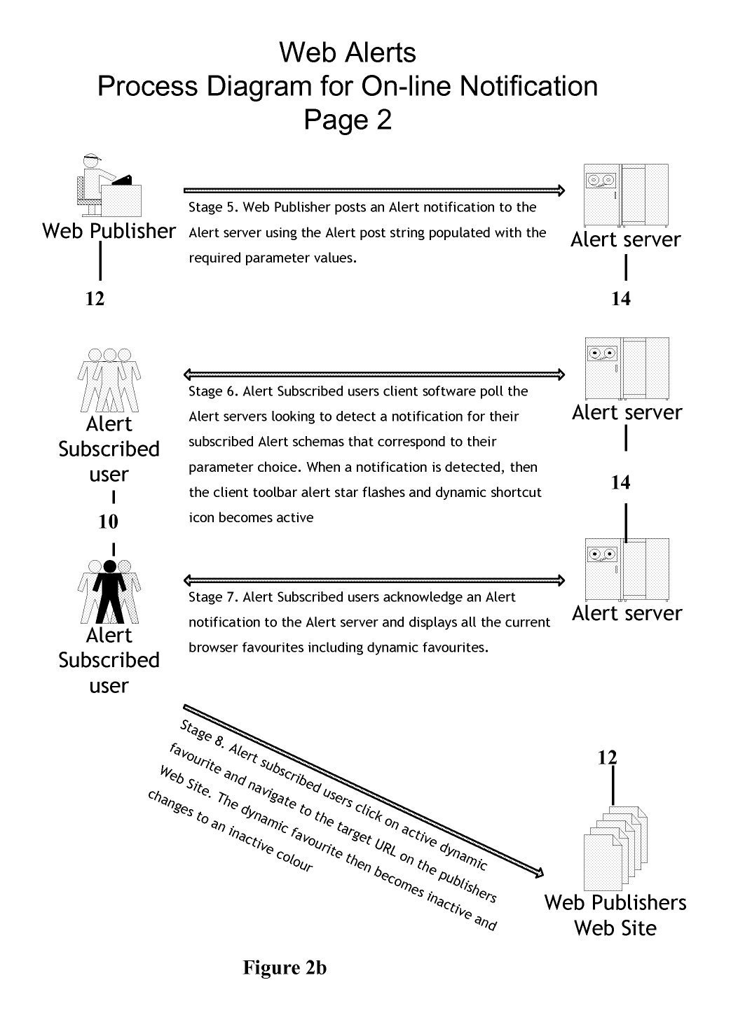

Using this linking code as an example, when an internet user decides to elect to receive alert messages from the publisher's website 16 by clicking on an object on the site that is hypertext linked to the linking code, Java script will have populated the parameter values in this case from the internet user selecting ‘etype’ from a drop down list for the ‘model’ parameter and entering ‘10000’ from a text box indicating the maximum price. If the user 10 has not already installed the client software they will be prompted to do so and to indicate whether they want an offline notification. The offline notification process is shown in FIG. 3. If offline notification is required, then the user 10 has to enter the details of the offline device to which the notification has to be sent. This information is stored at the alert server 14. The client software is then downloaded to the user.

Once the client software is installed, the internet user (now an alert subscriber) proceeds in the same fashion as an alert subscriber who already has the client software installed. In this case, a check is made to determine whether the web publisher 12 has provided for offline notification. If it is possible, the user 10 is prompted to register for an offline acknowledgement for the selected alert. If this option is selected, the user 10 will subscribe to an online and an offline notification, where the off-line notification is generally only used in the event that the user 10 is not on-line at the time the alert notification is generated. Where off-line notification is requested, the web publisher 12 never sees the mobile telephone number only the alert server 14 sees this. Hence, user anonymity is preserved fully as far as the web publisher is concerned 12. If offline notification is not possible, then the client software merely registers the alert details, so that it can identify any event notification associated with it at a later date, thereby to provide an online notification.

For the sake of illustration, consider the alert subscriber described above as subscriber ‘A’. This subscriber has subscribed to an alert that will notify him when an etype jaguar costing less than 10,000 dollars becomes available. Consider now another internet user also looking for an e-type, but who is only prepared to pay 8,000 dollars and again for illustration consider this subscriber as subscriber ‘B’. Finally consider a subscriber ‘C’ who also elects to subscribe for an alert for an ‘etype’ for a value of 8,500 dollars. In addition, subscriber ‘C’ has registered to receive offline messages to his mobile phone.

For this example the publisher 12 now wishes to alert subscribed users that he has a new vehicle available. He places a new page on his website that has an Etype Jaguar for 9,000 dollars, and generates a notification for sending to the alert server 14. The alert publisher 12 can generate the alert notification code manually or can use the alert server administration system to generate it automatically. In this case consider the publisher 12 generating the alert notification string automatically. The publisher 12 is prompted to enter values for their pre-defined parameters which in this case is the value ‘etype’ for the ‘model’ parameter and the value ‘9000’ for the price parameter. He must also include a target URL, which in this case is ‘www.elertzcars.com/new/etype1.html’. This information is then used to generate the following notification string:

http://www.elertz.com/new/update.aspx?webmaster_id=2=&target_url=http://www.elertzcars.com/new/etype1.html&notification_description=Classic car alert&schema_id=71&model=etype&price=9000

The notification string breaks down into the following components

http://elertz.com/new/update.aspx

The alert server side script that will record the notification parameters

webmaster_id=2

The unique web publisher identifier (in this case 2)

target_url=http://www.elertzcars.com/new/etype1.htm

The notification target URL

notification_description=Classic car alert:

schema_id=71:

Schema identifier (in this case 71)

model=etype:

Web publisher defined parameter ‘model’ with a value of ‘etype’

price=9000

Web publisher defined parameter ‘price’ with a value of ‘9000’

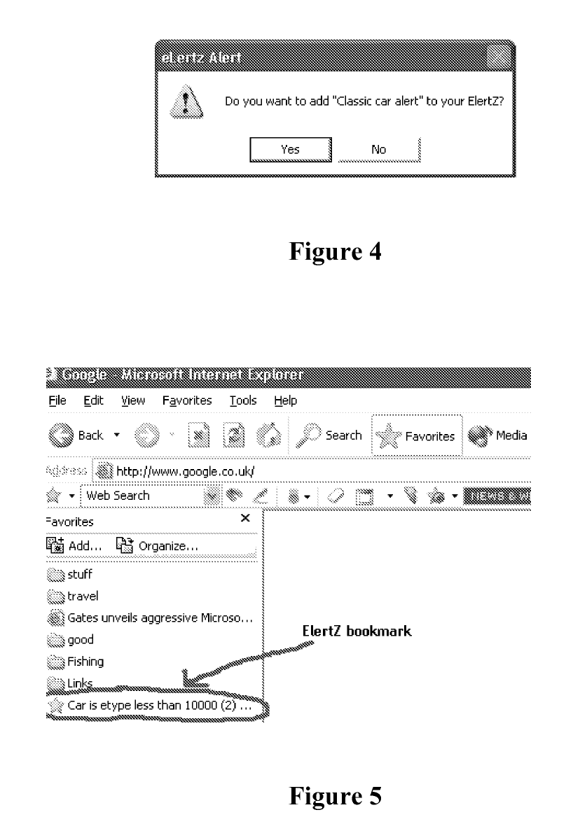

This notification string can be posted to the alert server 14 by cutting and pasting the string into a browser address box or automatically by pressing a button within the administration system. In either case, once posted, the alert server 14 is aware that a notification for the web publisher's alert schema has been fired. This event notification is then made available so that alert client software, which is polling the alert server regularly, can identify it. At this stage, the alert server 14 detects those alert subscribed users 10 who have elected for offline notification that have either closed down their client software or the server has received no polling for a nominated time out period. The process for doing this is shown in FIG. 6. For this example consider subscribers A and B to be logged in whilst subscriber C is logged out.

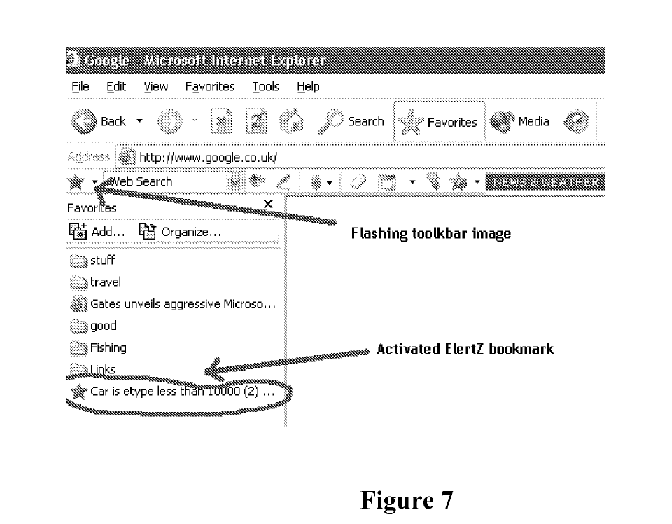

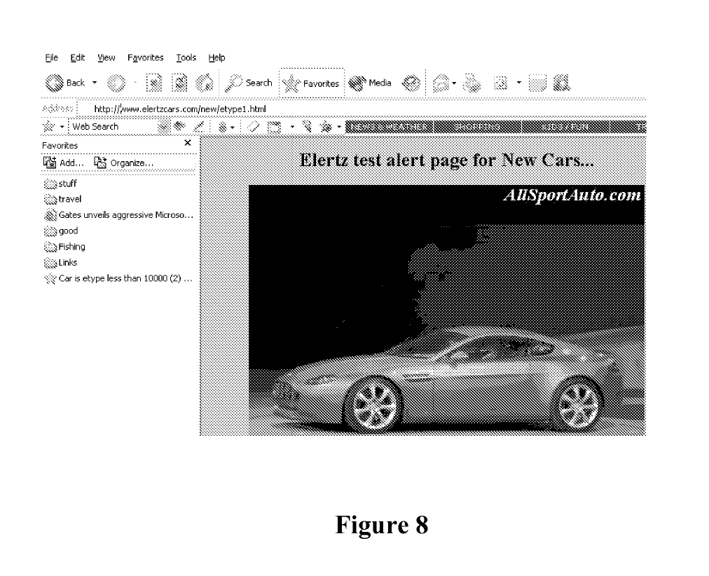

When the event notification is posted, subscriber A's client software, which polls the alert server 14 regularly, receives a reply from the alert server 14 that an ‘etype’ for less than 10,000 dollars is available. The client software bookmark URL is updated with the target URL of ‘www.elertzcars.com/new/etype1.html’ and the bookmark condition is changed to active (typically an associated star icon with the bookmark changes from yellow to red), as shown in FIG. 7. In addition, the client software icon in the toolbar flashes an image (typically a star) to indicate a subscribed alert has been activated. Once the subscribed user 10 clicks on the bookmark they will navigate to the target URL, as shown in FIG. 8. At this point, the alert notification has been acknowledged and the bookmark icon returns to its pre-alerted state (typically the bookmark star icon goes yellow). If no further subscribed alert notifications are outstanding then the client software image reverts to its normal unexcited state (typically non flashing yellow star).

Whilst in the above example subscriber A receives an alert, subscriber B gets no event notification as their requirement is for an ‘etype’ less than 8,000 dollars. In contrast, for subscriber C an alert notification is provided. However, because in this example, C has terminated his client software, and because he has registered for offline notifications using his mobile phone, the alert server 14 sends a text message to subscriber ‘C’s mobile phone with the message ‘A new etype for 9000 dollars has just been made available at www.elertzcars.com/new/etype1.html.’

The present invention is a pull technology that depends on the utilisation of client software embedded in a toolbar. The alert and the parameters of the alert are defined by the web publisher 12 in the parameters of a server side script processed as a hypertext link on the publisher's web site 16. The server side script will, by default try to install the client toolbar software. However, if the client toolbar software is already installed, this is detected by the client software, which simply just adds the alert. The alert manifests itself as an additional dynamic bookmark in the browser with a special icon to distinguish it from regular browser favourites (typically a yellow start). The alert details are also stored in the alert server 14. When the publisher 12 posts an update to the alert, this is noted in a database at the server. The client software polls the alert servers 14 regularly, for example every 30 seconds. If an alert is detected within the range of the user selected parameter values, it flashes the alert detector star in the toolbar and turns the dynamic favourite icon red for active. Selection of the icon directs the user to the target URL. Once the user 10 navigates to the target URL the dynamic bookmark icon goes back to an inactive yellow colour. To de-select an alert, the user 10 merely deletes the dynamic favourite, and so the client software no longer polls this alert.

The system and method in which the invention is embodied are real time rather than email based. This gives complete control to the publisher 12 on issuing alerts and does not use RSS. The alert process is totally generic and can be utilised by any website and can be automatically utilised by any toolbar that is alert enabled. The provisioning of the alerts can be done completely by the publisher and does not require any third party intervention for deployment. The process is totally HTML based and does not require any bespoke programming to deliver the alerts either from the publisher 12 or the end user 10. In addition, the alert subscribed user 10 is in complete control of the process. If they end up receiving too many alerts from a particular site or they are of no further interest to them, subscribed users 10 can delete them just by right mouse clicking on the dynamic bookmark and then selecting the delete option preventing unsolicited messaging from the publisher 12.

A skilled person will appreciate that variations of the disclosed arrangements are possible without departing from the invention. For example, although the figures show a single alert server 14, it will be appreciated a distributed network of such servers/processors could equally be used. Equally, whilst FIGS. 1 and 2 show only a single user terminal, a single website and a single web publisher 12, it will be appreciated that multiple websites provided by one or more different web publishers could have alerts registered with the alert server 14 and multiple users 10 would in practice use the system, each user 10 being able to subscribe to alerts on multiple different websites. Whilst the system in which the invention is embodied provides a mechanism for complete user anonymity, in some implementations (such as internet banking), the publisher 12 may explicitly associate the user's GUID with an account number. Accordingly the above description of the specific embodiment is made by way of example only and not for the purposes of limitation. It is clear that minor modifications may be made without significant changes to the operation described.

1. A method for providing a non-email based precision web alert, the alert being provided on a web-site or web-based application by a web-publisher, the method comprising:
registering at least one alert at an alert server;
presenting a user selectable alert on a web-site or web-based application;
allowing user selection of the alert and definition of at least one user variable, including at least one of a parameter and/or operator and/or threshold associated with the alert;
generating at the alert server an event notification when an event associated with the alert has occurred; and
using dedicated alert software at the user's terminal to contact the alert server to identify any event notifications for alerts that the user selected, and when an event notification is identified generate an alert notification at the user's terminal.

2. A method as claimed in claim 1 wherein the user is anonymous to the web-publisher.

3. A method as claimed in claim 1 wherein the alert selection/de-selection is under complete user control.

4. A method as claimed in claim 1 wherein the user selectable parameter and/or operator and/or threshold are defined by the web publisher and made available for user selection.

5. A method as claimed in claim 1 wherein the user selectable operators include one or more Boolean operators.

6. A method as claimed in claim 5 wherein the Boolean operators include at least one of ‘Equal to’; ‘Less than’; ‘Greater than’ and ‘Not equal to’.

7. A method as claimed in claim 1 comprising including the alert notification as a temporary entry in a favourites list of the user's internet browser.

8. A method as claimed in claim 1 wherein the alert notification at the user's terminal includes a link to a target address, preferably a URL.

9. A method as claimed in claim 1 further involving receiving alert information from a web publisher and providing alert code for the publisher to include on their web-site, the alert code including a link to the alert server.

10. A method as claimed in claim 9 wherein the link is a URL.

11. A method as claimed in claim 1 causing the alert software to be downloaded to the user's terminal.

12. A method as claimed in claim 1 wherein the alert software consists solely of HMTL.

13. A method as claimed in claim 1 comprising providing the option of sending an alert to an offline device nominated by the user, such as a mobile phone, when the user is not available to receive on-line alerts.

14. A method as claimed in claim 1 wherein the event notification includes a link to a target website or web-based application.

15. A method as claimed in claim 14 wherein the target link is a URL.

16. A method as claimed in claim 14 wherein the alert software at the user's terminal is operable to capture the link from the event notification and use it to allow the user to navigate to the target address.

17. A non-email based precision web alert system for providing an alert on a web-site or web-based application, the system being configured to:
register at least one alert at an alert server;
present the alert on a web-site or web-based application;
receive a user selection of the alert, and at least one parameter and/or operator and/or threshold associated with it;
generate at the alert server an event notification when an event associated with the alert has occurred; and
use dedicated alert software at the user's terminal to contact the alert server to identify any event notifications for alerts that the user selected and when an event notification is identified generate an alert notification at the user's terminal.

18. A system for alerting an anonymous user to events on an internet web page or site or internet based application, the system comprising:
an alert server for registering an alert; receiving from a website publisher an indication of an event associated with the alert, and generating an event notification indicating that an event associated with the alert has occurred; and
alert software at the user's terminal for contacting the alert server to identify an associated event notification for an alert that the user has subscribed to and in the event that an event notification is identified generate an alert notification at the user's terminal.

19. A system as claimed in claim 18 arranged to provide alert code for the publisher to include on their website, the alert code including a link to the alert server.

20. A system as claimed in claim 19 wherein the link is user selectable and operable to allow a user to a register to receive event information associated with the link, wherein the registration information is stored at the alert software.

21. A system as claimed in claim 20 arranged to cause an alert registration identifier to be created at the user's browser in response to registering an alert.

22. A system as claimed in claim 21 arranged to cause a change to the alert registration identifier in response to identification of an event notification for that alert, the change acting as the alert notification.

23. A system as claimed in claim 21 wherein the alert registration identifier is an entry in a favourites list in the user's browser.

24. A system as claimed in claim 17 wherein the alert software is operable to store at least one user selected parameter and/or operator and/or threshold associated with the alert.

25. A system as claimed in claim 24 wherein the user-selected operator is a Boolean operator.

26. A system as claimed in claim 25 wherein the Boolean operator is at least one of ‘Equal to’; ‘Less than’; ‘Greater than’ and ‘Not equal to’.

27. An alert server for use in the method or system of any of the preceding claims.

28. A computer program, preferably on a data carrier or a computer readable medium, the program having code or instructions for:
storing at least one alert subscription identifier received from a website in response to a user selection of an alert;
contacting an alert server for event notifications indicative of events associated with the or each subscribed to alerts; and
generating an alert message at the user's terminal in the event that an event notification is identified.

29. A computer program as claimed in claim 28 wherein the alert message is included in the user's browser, for example, in the user's favourites list.

30. A computer program as claimed in claim 28, wherein the alert message is user selectable.

31. A computer program as claimed in claim 30 wherein the alert message is arranged to cause the browser to navigate to target URL that is associated with the alert.

32. A computer program as claimed in claim 28 including code or instructions to notify the alert server when it is active and/or inactive.

33. A computer program as claimed in claim 32 including code or instructions to notify the alert server of a diversion of alert notifications to a subscriber's offline device.

34. A computer program as claimed in claim 33 wherein the off-line device is a PDA or mobile telephone.
